(19) United States
(12) Patent Application Publication
(10) Pub. No.: US 2005/0167606 A1
(43) Pub. Date: Aug. 4, 2005

(54) Cadmium-zinc-telluride detectors

(76) Inventors: Fiona A. Harrison, Los Angeles, CA (US); Walter Cook, Long Beach, CA (US); Chi Ming Hubert Chen, Monterey Park, CA (US); Branislav Kecman, Pasadena, CA (US); Peter Hsih-Jer Mao, Los Angeles, CA (US); Stephen M. Schindler, Big Sur, CA (US); Jill Bumham, Pasadena, CA (US)

Correspondence Address: Tope-McKay & Associates, 23852 Pacific Coast Hwy # 0038, Malibu, CA, 90265, US

(21) Appl. No.: 10/923,249

(22) Filed: Aug. 20, 2004

Related U.S. Application Data
(60) Provisional application No. 60/496,899, filed on Aug. 20, 2003.

(51) Int. Cl. G01T 1/24

(52) U.S. Cl. 250/370.13; 250/395

(57) ABSTRACT

The present invention relates to cadmium-zinc-telluride (CdZnTe) detectors. More specifically, the present invention relates CdZnTe pixel detectors that are optimized for astrophysical applications.

### PRIORITY CLAIM

The present application claims the benefit of priority of U.S. Provisional Patent Application No. 60/496,899, filed Aug. 20, 2003, entitled “Characterization of the HEFT CdZnTe pixel detectors.”

### STATEMENT OF GOVERNMENT INTEREST

This invention is related to work performed in contract with the U.S. Government under the National Aeronautics and Space Administration (NASA) contract number #NAS7-1407, and the U.S. Government may have certain rights in this invention.

### BACKGROUND OF THE INVENTION

(1) Technical Field

The present invention relates to cadmium-zinc-telluride (CdZnTe) detectors. More specifically, the present invention relates CdZnTe pixel detectors that are optimized for astrophysical applications.

(2) Background

The High Energy Focusing Telescope (HEFT) is a balloon-borne experiment employing focusing optics in the hard X-ray/soft gamma-ray, 20-100 kiloelectron-volts (keV), spectra for sensitive observations of astrophysical sources. One scientific objective includes imaging and spectroscopy of titanium emissions in young supernova remnants, sensitive hard X-ray observations of obscured active galactic nuclei, and spectroscopic observations of accreting high-magnetic field pulsars.

Large-area focusing telescopes have generally been limited to the soft X-ray band by technical difficulties associated with extending grazing incidence X-ray optics to high energy and the lack of high-spatial resolution hard X-ray detectors. The recent development of depth-graded multilayer optics and high-Z solid state pixel detectors has made true focusing possible at high X-ray energies. This advance provides dramatic improvements in sensitivity and angular resolution not achievable with the current generation of background-limited collimated and coded-aperture hard X-ray instruments.

### SUMMARY OF THE INVENTION

The present invention provides a system and a method that overcomes the aforementioned limitations and fills the aforementioned needs by providing a CdZnTe detector which is optimized for astrophysical applications.

In one aspect of the invention, a detector system comprises a patterned CdZnTe detector; an ASIC bonded with the CdZnTe detector for receiving a signal from the CdZnTe detector; and a microprocessor connected with the ASIC for operating the ASIC, wherein signals are received by the CdZnTe detector, passed through the ASIC, and processed by the microprocessor.

In another aspect, the patterned CdZnTe detector comprises a single CdZnTe crystal having a first side and a second side; a anode plane connected with the first side of the CdZnTe crystal, wherein the anode plane comprises a plurality of pixels; and a guard ring surrounding the plurality of pixels; and a cathode connected with the second side of the CdZnTe crystal.

In yet another aspect, the anode plane further comprises a grid, wherein the grid separates a first pixel from a second pixel in the plurality of pixels.

In still another aspect, the ASIC comprises a preamplifier having a preamplifier output, a shaping amplifier connected with the preamplifier output, a discriminator connected with the shaping amplifier for identifying a desired signal, and a sampling and pulsing circuit connected with the preamplifier output.

In another aspect, the sampling and pulsing circuits comprise a plurality of switched capacitors.

It can be appreciated by one in the art that the present invention also comprises a method of making a detector system. For example, the method comprises acts of bonding a CdZnTe detector to an ASIC, and connecting a microprocessor to the ASIC.

The act of making the detector system, wherein the act of bonding is selected from a group consisting of: indium bump bonding and conductive epoxy and gold stump bonding.

The act of making the detector system further comprises the act of patterning the CdZnTe detector.

The act of making the detector system, wherein the act of patterning is selected from a group consisting of: patterning the CdZnTe detector by forming a plurality of pixels separated by a gap and patterning the CdZnTe detector by forming a plurality of pixels separated by a gap and a gird.

It can be appreciated by one in the art that the present invention also comprises a method of determining event triggers comprising acts of: preliminary screening event triggers for events that trigger more than one-pixel or non-adjacent pixels; removing systematic noise; calculating a first pulse height resulting in a first pulse height calculation; passing the first pulse height calculation to a discriminator; eliminating false triggers; calculating a second pulse height; and summing any second pulse height pairs that result from adjacent-pixel triggers.

### BRIEF DESCRIPTION OF THE DRAWINGS

The objects, features and advantages of the present invention will be apparent from the following detailed descriptions of the preferred aspect of the invention in conjunction with reference to the following drawings.

FIG. 1A depicts a sketch of a patterned CdZnTe crystal in accordance with one embodiment of the present invention;

FIG. 1B depicts an enlarged view of a section of a gridded patterned CdZnTe crystal in accordance with one embodiment of the present invention;

FIG. 1C depicts an enlarged view of a section of a non-gridded patterned CdZnTe crystal in accordance with another embodiment of the present invention;

FIG. 2 depicts a block diagram of one embodiment of a detector system in accordance with the present invention;

FIG. 3 depicts a block diagram of circuitry used to implement one application-specific integrated circuit pixel in accordance with the present invention;

FIG. 4 is a software processing sequence that may be used in pulse height recovery in accordance with the present invention;

FIG. 5 is a depiction of the distribution of electronic noise for the gridded detector in accordance with one embodiment of the present invention;

FIG. 6 is a depiction of the distribution of the line widths for the 110 pixels under the collimator for both the gridded and non-gridded detector in accordance with the present invention;

FIG. 7a is an intensity map depicting the spatial distribution of the gridded detector in accordance with the present invention;

FIG. 7b is an intensity map depicting the spatial distribution of the non-gridded detector in accordance with the present invention;

FIG. 8a depicts the summed spectra from all pixels for the gridded detector in accordance with one embodiment of the present invention;

FIG. 8b depicts the summed spectra form all pixels fro the non-gridded detector in accordance with one embodiment of the present invention.

FIG. 9a depicts the specra from the gridded detector obtained from charge-sharing events in accordance with one embodiment of the present invention;

FIG. 9b depicts the spectra from the non-gridded detector obtained from charge-sharing events in accordance with one embodiment of the present invention;

FIG. 10a depicts the spectra for the gridded detector when the single-pixel and charge-sharing events are summed together in accordance with one embodiment of the present invention;

FIG. 10b depicts the spectra for the non-gridded detector when the single-pixel and charge-sharing events are summed together in accordance with one embodiment of the present invention;

FIG. 11a shows the trend of the full width half maximum for various bias combinations at the cathode and the steering electrode of the gridded detector in accordance with one embodiment of the present invention; and

FIG. 11b shows the trend of the skewness for various bias combinations at the cathode and the steering electrode of the gridded detector in accordance with one embodiment of the present invention.

### DETAILED DESCRIPTION

The present invention relates to cadmium-zinc-telluride (CdZnTe) detectors. More specifically, the present invention relates CdZnTe pixel detectors that are optimized for astrophysical applications. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles, defined herein, may be applied to a wide range of embodiments. Thus, the present invention is not intended to be limited to the embodiments presented, but is to be accorded the widest scope consistent with the principles and novel features disclosed herein. Furthermore, it should be noted that unless explicitly stated otherwise, the figures included herein are illustrated diagrammatically and without any specific scale, as they are provided as qualitative illustrations of the concept of the present invention.

(1) Introduction

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

The description outlined below sets forth cadmium-zinc-telluride (CdZnTe) detectors. More specifically, the description sets forth CdZnTe pixel detectors that are optimized for astrophysical applications. The description also includes several embodiments of a detector system comprising the CdZnTe pixel detectors.

(2) Sensor Details

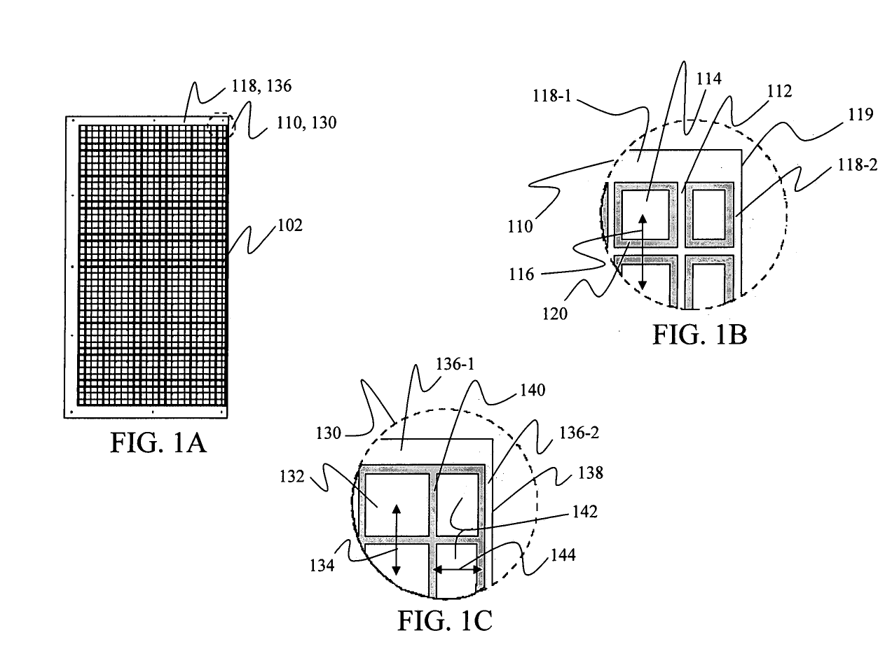

FIG. 1A depicts a sketch of a patterned CdZnTe crystal 102. CdZnTe crystals with platinum electrodes are available from eV Products, 373 Saxonburg Blvd., Saxonburg, Pa. 16056. In one, non-limiting, embodiment the CdZnTe crystal 102 is 23.6 millimeters (mm) by 12.9 mm by 2 mm thick. One skilled in the art will appreciate that the CdZnTe crystal may be larger or smaller depending upon the design specifications. In one embodiment, the size of the crystal is limited by the availability of CdZnTe crystals, which comprise a single crystal of highly uniform material.

FIG. 1B is an enlarged view of a section of the patterned CdZnTe crystal 102 in accordance with a first embodiment. FIG. 1C is an enlarged view of a section of the patterned CdZnTe crystal 102 in accordance with a second embodiment. The first embodiment is herein referred to as a gridded pattern detector 110, and the second embodiment is herein referred to as a non-gridded pattern detector 130.

FIG. 1B depicts the patterned CdZnTe crystal 102 in which the anode plane pattern has a shaping electrode, or grid 112, between pixel contacts 114. In one embodiment of this gridded pattern detector 110, the cathode, which is the underside of the CdZnTe crystal 102 and not shown in FIG. 1B, has a monolithic platinum contact, while the anode plane 102 is patterned into a 24×44 pixel array of 498 micrometer (μm) pitch 116, surrounded by a first portion 118-1 of a guard ring 118 that is 1 mm and a second portion 118-2 of the guard ring 118 which is 0.1 mm. One skilled in the art will appreciate that in one embodiment the guard ring 118 has four sides, three sides comprising the first portion 118-1 of the guard ring 118 and a fourth side comprising the second portion 118-2 of the guard ring 118, whereby the guard ring 118 surrounds all of the outer pixel contacts belonging to a given crystal 102. This guard ring 118 configuration allows two detectors to be placed side by side to form a roughly square sensor area with minimal dead area in between. The second portion 118-2 of the guard ring 118 is a mating edge 119. There is a 50 μm gap 120 between the anode 114 and the grid 112. The grid 112 is 14 μm wide. Further, the mating edge pixels 122 have a 300 μm pitch 124 along the mating edge 119.

FIG. 1C depicts the patterned CdZnTe crystal 102 in which the anode plane does not have a grid between pixel contacts 132. In one embodiment of this non-gridded pattern detector 130, the cathode, which is the underside of the CdZnTe crystal 102, and not shown in FIG. 1C, has a monolithic platinum contact, while the anode plane 102 is patterned into a 24×44 pixel array of 498 μm pitch 134, surrounded by a first portion 136-1 of a guard ring 136 that is 1 mm, and a second portion 136-2 of the guard ring 136 which is 0.1 mm. One skilled in the art will appreciate that in one embodiment the guard ring 136 has four sides, three sides comprising the first portion 136-1 of the guard ring 136 and a fourth side comprising the second portion 136-2 of the guard ring 136, whereby the guard ring 136 surrounds all of the outer pixel contacts belonging to a given crystal 102. This guard ring 136 configuration allows two detectors to be placed side by side to form a roughly square sensor area with minimal dead area in between. The second portion 136-2 of the guard ring 136 is the mating edge 138. There is a 30 μm gap 140 between pixel contacts 132. The mating edge pixels 142 have a 300 μm pitch 144 along the mating edge 138.

(3) Detector System Details

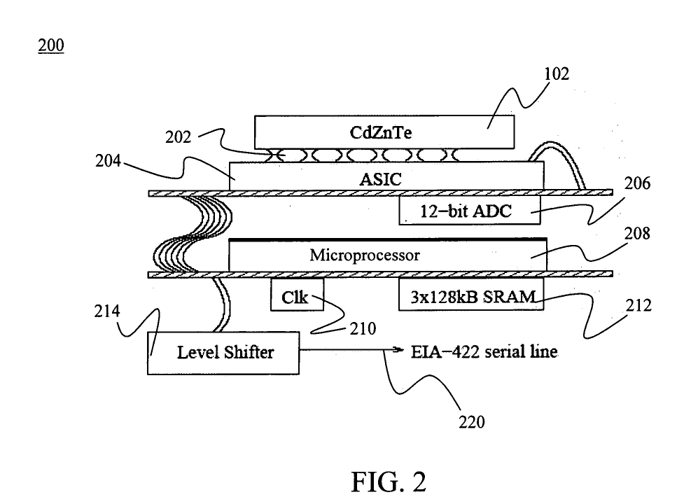

FIG. 2 depicts a block diagram of one embodiment of a detector system 200. The detector system 200 comprises one of the previously described CdZnTe crystals 102 with a bond 202 to an application-specific integrated circuit (ASIC) 204. The bond may consist of indium bump bonding, conductive epoxy, and gold stump bonding. The detector system 200 also comprises an analog-to-digital converter (ADC) 206 connected to the ASIC 204 output, and a microprocessor 208 for operating the ASIC 204. One skilled in the art will appreciate that a microprocessor 208 may require support electronics such as a clock 210 and memory 212.

In one embodiment the microprocessor 208 is a 24-bit Minimal Instruction Set Computer (MISC) implemented on an Actel A54SX72A field programmable gate array (FPGA), available from Actel, 2061 Stierlin Ct., Mountain View, Calif., 94043, having a Forth Core Processor Design. The MISC runs on a 7.3728 MHz clock cycle, driven by a 14.7456 MHz oscillator chip 210. The microprocessor 208 is connected with 128 kilobytes of 24-bit memory provided by three 128 kilobyte Static Random Access Memories (SRAMS) 212. The output of the ASIC 204 readout line is digitized by an 80 milliwatt, 12-bit ADC12062 206, available from National Semiconductor, 2900 Semiconductor Dr., P.O. Box 58090, Santa Clara, Calif., 95052. The microprocessor 208 then pipes the digitized data out to an EIA-422 serial line 220 via a level shifter 214.

In one embodiment the CdZnTe crystal 102 is a gridded pattern detector 110 as shown in FIG. 1B. In this embodiment, the bonds 202 are 8-10 micrometer tall indium bumps. One skilled in the art will appreciate that reducing the anode contact size reduces the input capacitance, thus improving system performance. This reduced anode contact size results in a larger gap between contacts; therefore, the grid 112 is added. The grid 112 is held at a potential in between a cathode potential and an anode potential to steer charge hitting the surface between pixels toward the anode, thus minimizing charge loss in the gap.

In a second embodiment the CdZnTe crystal 102 is a non-gridded pattern detector 130 as shown in FIG. 1C. In this embodiment, the bonds 202 are a series of conductive epoxy bumps disposed on the CdZnTe crystal 102 and gold stud bumps disposed on the ASIC 204. These epoxy and gold stud bumps are approximately 40 micrometers tall. The epoxy and gold stud bumps result in a separation of the CdZnTe crystal 102 from the ASIC 204, thus a larger anode contact size is allowed compared to the anode size allowed by the indium bump method to achieve the same input capacitance. The result is no grid is needed.

In one embodiment, minimizing detector noise requires that no underfill epoxy be used for this assembly of the non-gridded pattern detector. Mechanical integrity at near-zero temperature depends on the large number of epoxy bonds, along with an approximate match in the coefficient of thermal expansion (CTE) of the materials. This assembly also requires that none of the epoxy bumps come into contact with the pads on the ASIC chip. Thus, in one embodiment, a stencil printing technique is utilized to control the deposit of the epoxy bumps to a very precise mass and uniform shape.

(4) ASIC Details

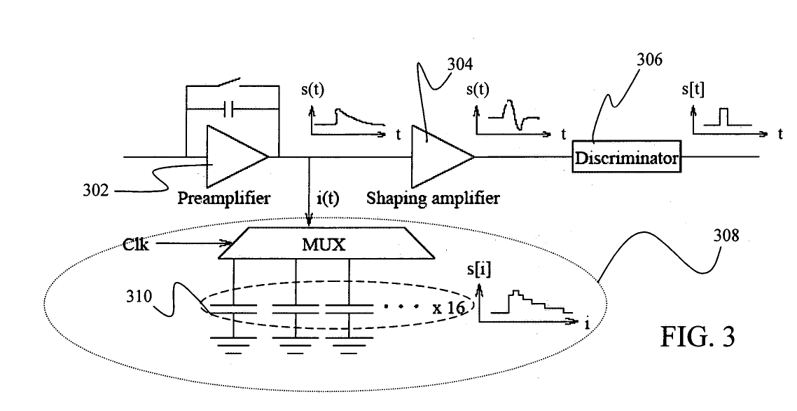

The ASIC 204 comprises a pixel pattern that matches the pixel pattern of the CdTeZn crystal 102. Therefore, in one embodiment, the ASIC 204 comprises a 24×44 pixel array having a 498 micrometer pitch. FIG. 3 depicts one embodiment of the circuitry used to implement one ASIC 204 pixel. Each pixel within the ASIC 204 is implemented with its own preamplifier 302, shaping amplifier 304, discriminator 306, and sampling and pulsing circuits 308. All pixels share a serial readout line not shown. The discriminator functions to identify the desired signal received from the shaping amplifier.

In one embodiment, the ASIC 204 is optimized for lower noise and power and good spectral resolution, consuming approximately 50 milliwatts (mW) under nominal operation. In order to achieve low power, signal shaping and peak detection stages of a conventional amplifier chain are replaced by a bank of sixteen switch capacitors 310, shown in FIG. 3, arranged to continuously capture successive samples of the pre-amplifier's 302 output. This results in a large reduction in power dissipation, from 250 microwatts to 50 microwatts per pixel, while allowing off-chip digital signal processing to extract near optimal energy resolution.

As shown in FIG. 3, the pre-amplifier's 302 output is converted to a current and is integrated by the capacitors, cyclically one by one, with a one microsecond integration time. This process gives a record of the current level during the previous 15-16 microseconds at any given time. When a trigger is detected, sampling continues for eight more samples, after which the circuit freezes while the samples are read out on the serial readout line 220, shown in FIG. 2.

In addition to reading out the 16 samples from each triggered pixel, samples are also read out from a collection of other pixels for additional information to assist with the pulse height recovery process. These other pixels include all the ones neighboring any triggering pixel, i.e. those sharing an edge or a corner with a triggering pixel, and a 3×3 array of reference pixels remote from the triggered pixels. Samples at the neighboring pixels contain any systematic noise that is common in the vicinity of the triggering pixel, while samples at the reference pixels contain noise that is common to the entire chip. The neighboring pixels may also have collected a small fraction of the charge induced from the X-ray event, if the event has occurred near the edge of the triggering pixel, and this charge may be too small to have triggered the neighboring pixel. With these additional samples, a second discriminator is implemented with a much lower threshold, and systematic noise is also removed from the triggered pixels. In one embodiment the second discriminator is implemented in software.

An event triggering a single pixel involves reading out 16 samples from 3×3+3×3=18 pixels, which is 18×16=288 12-bit numbers. An event where two adjacent pixels trigger, which is termed a charge-sharing event, requires reading out 16 samples from 4×3+3×3=21 pixels, which is 21×16=336 12-bit numbers. With additional information, such as pixel coordinates, time information, etc., each event produces about 0.5 kilobytes of information. The read-out process takes about 30 milliseconds. In one embodiment, having one ADC for two hybrid sensors, the focal plane can tolerate count rates of up to 100 counts per second before saturating.

(5) Software Processing

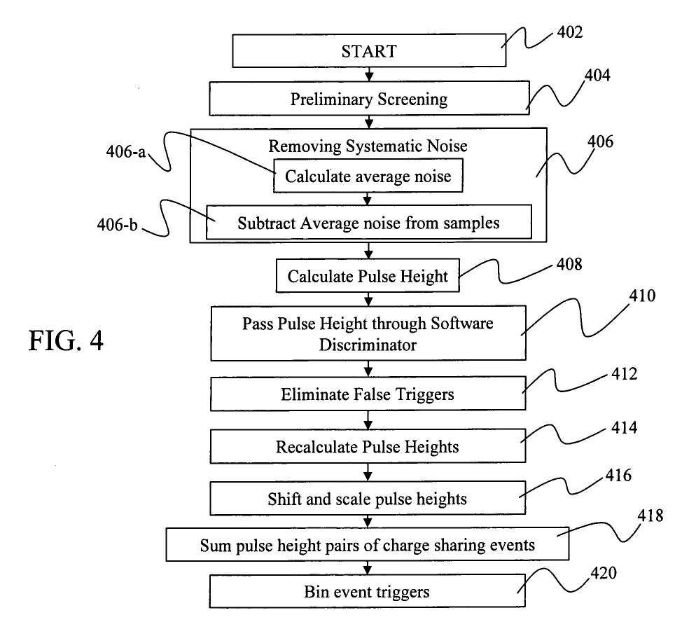

As is alluded to above, much of the signal processing is delegated off-chip. Thus, software processing determines the quality of pulse height recovery. FIG. 4 depicts one embodiment of a software processing sequence that may be used in pulse height recovery. After starting 403, the software processing sequence begins with an act of preliminary screening 404 of the event record, which screens out abnormal events. In most of these abnormal events, where there are either more than two triggering pixels, or two triggering pixels that do not share a common edge, noise is the most common cause for these events. Detector modeling results have been reported in C. M. H. Chen, S. E. Boggs, A. E. Bolotnikov, W. R. Cook, F. A. Harrison, and S. M. Schindler, “Numerical modeling of charge sharing in CdZnTe pixel detectors,” IEEE Transactions in Nuclear Science 49, pp. 270-276, February 2002, herein incorporated by reference. The detector modeling results have shown that no more than 3% of all events will have charge shared amongst three or more pixels. The rate of having two photon events occurring within a one microsecond period is low. Other events that are screened out by this process include the occasional, a few times in a million, occurrence of bad encodings, and events occurring too soon after a circuit resets, when the quiescent signal level has not been stabilized yet.

The next stage of processing involves an act of removing systematic noise 406 common to all pixels. First, an act of calculating an average noise level 406-a is performed. In one embodiment, the average noise level is an average of the noise level measured at the nine reference pixels. Next, for each of the 16 integration periods in an event record, an act of subtracting the average noise level from the samples 406-b measured at the triggering and neighboring pixels is performed. Then, an act of calculating a pulse height 408 is performed. In one embodiment the act of calculating a pulse height 408 is performed from each pixel that has a noise-corrected sample in the sequence, as the difference between the average of the last six samples and the average of the first six samples in the sequence. Next, an act of passing the pulse heights through a software discriminator 410 is performed. The act of passing 410 allows for a search of charge-sharing events that are hidden from the hardware discriminator circuit by noise. Because the common noise has been removed, the software detection threshold can be set below 1 keV, as opposed to the hardware detection threshold near 8 keV. At this stage, an act of eliminating false triggers 412 is also performed.

For the single-pixel and two-pixel (charge-sharing) events that remain, an act of recalculating their pulse heights 414 is performed with a formula that takes the values of all 16 noise-corrected samples into account. Next, an act of shifting and scaling the pulse heights 416 is performed to compensate for difference in amplifier gains and capacitor offsets across the pixels. Then an act of summing the pulse height pairs in charge-sharing events 418 is performed. Finally, an act of binning all event triggers 420 is performed to produce spectra and other related information.

(6) Experimental Results

This section presents detector performance under a range of temperatures and bias voltages for both architectures: the gridded detector with indium bumps, shown FIG. 1B and FIG. 2, and the detector with no grid, bonded with epoxy studs, shown in FIG. 1C and FIG. 2. The tested embodiment comprised a contiguous area of 10×11 pixels.

(6a) Electronic Noise

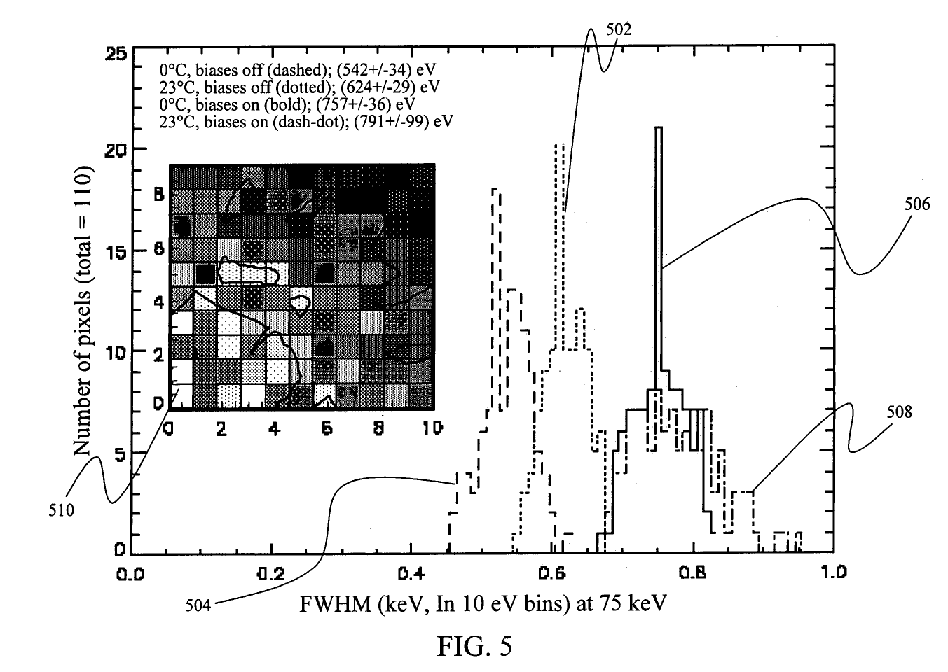

The intrinsic energy resolution of the detector hybrid at low X-ray energies is predominately determined by the electronic noise in the ASIC circuitry. The electronic noise is measured as the full-width at half-maximum (FWHM) of a Gaussian spectral line produced by electronic pulses with energies equivalent to 75 keV photons. The distribution of electronic noise for the gridded detector is shown in FIG. 5.

The dotted line 502 and dashed line 504 in FIG. 5 show the distributions of the electronic noise for 110 pixels, at room temperature, approximately 22 degrees Celsius, and at 0 degrees Celsius respectively, when all electrode biases are set to zero. Zero bias ensures that the measurement of the noise component is from the electronics themselves, rather than shot noise caused by leakage current though the CdZnTe crystal that is channeled into the preamplifier inputs. At room temperature, the ASIC design has an energy resolution of 624±29 eV FWHM at 74 keV, due to thermal noise in the circuitry; at 0 degrees Celsius, jitter in the circuitry decreases, and the resolution is improved slightly to 542±34 eV FWHM at 75 keV. If pulses at these pixels are summed together, the resulting 75 keV line has a FWHM of 623 eV at room temperature and 540 eV at 0 degrees Celsius.

For the gridded detector, leakage current is introduced by surface leakage between the grid and contact, as well as by bulk leakage. The magnitude of the contribution depends on the surface and bulk resistivities, which vary from detector to detector, and the operating bias voltage. For the gridded detector evaluated, when the biases are set to nominal values of −300 volts (V) at the cathode and −4 volts (V) at the steering electrode grid, both relative to the anodes, noise is introduced by surface leakage current, and the resolution degrades to 791±99 eV at room temperature and 757±36 eV at zero degrees Celsius. The resolutions in the summed spectra are 779 eV and 75 eV FWHM, respectively. The solid 506 and dashed-dot 508 lines in FIG. 5 show the FWHM distribution at the same 110 pixels at these biases. For the detector without a grid, the leakage current results from the bulk leakage component only. The inset map 510 shows the spatial distribution of the same data, with brightness proportional to the noise magnitude.

To characterize the response of the detectors to X-ray events, and thus the performance of the CdZnTe sensors, the detectors were tested with an Americium-241 (Am-241) source collimated into a circular beam with 10 to 11 pixel (5 millimeter) diameter.

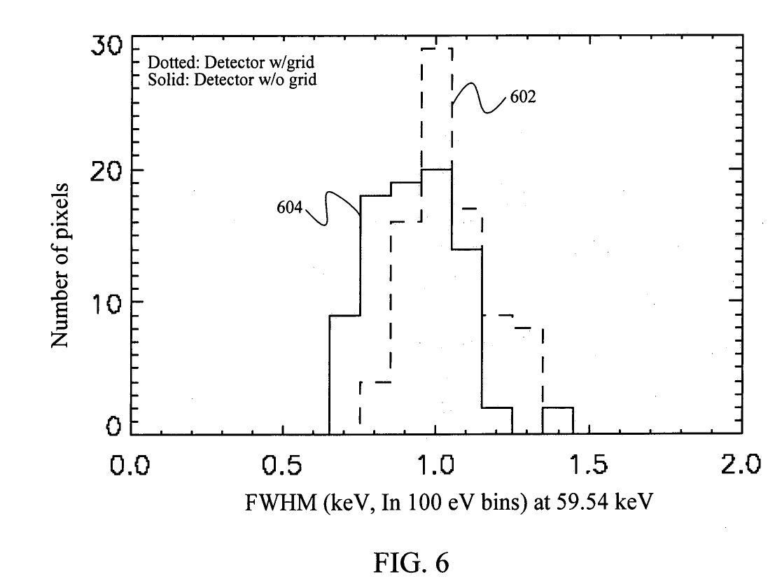

FIG. 6 shows the distribution of the 59.54 keV line widths for the 110 pixels under the collimator at each detector. The measurements were made at zero degrees Celsius, the targeted operating temperature for HEFT. The plot shows only events triggering one pixel. For the gridded detector, shown by the dotted line 602, with 10 micrometer indium bumps, the energy resolution ranges from 0.8 to 1.4 keV FWHM at 59.54 keV, with the majority of the pixels having 1.0 keV FWHM. For the non-gridded detector, shown by the solid line 604, with 40 micrometer high epoxy and stud bumps, the average energy resolution is improved by an average of approximately 0.1 keV.

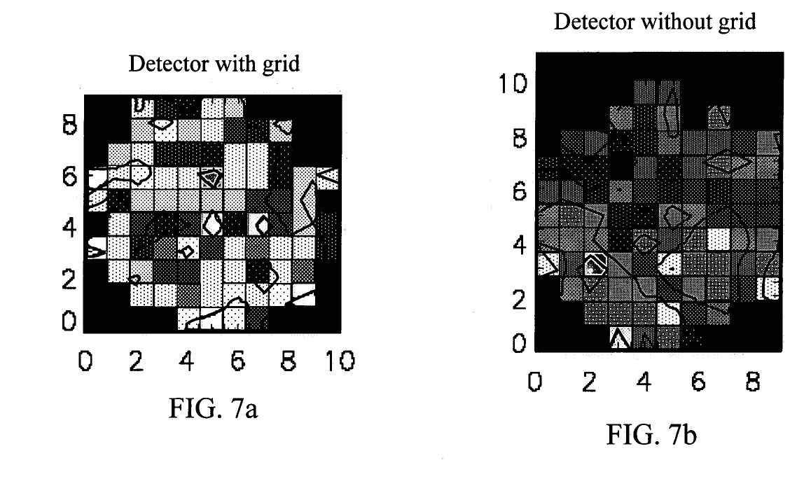

The intensity maps FIG. 7a and FIG. 7b depict the spatial distribution of the line widths. FIG. 7a depicts the spatial distribution of the gridded detector, and FIG. 7b depicts the spatial distribution of the non-gridded detector. Both intensity maps are drawn with the brightness proportional to the line width. One skilled in the art will appreciate that the pixels in the corners are shielded from the source by the circular collimator opening, thus these pixels are not included in the histogram shown in FIG. 6.

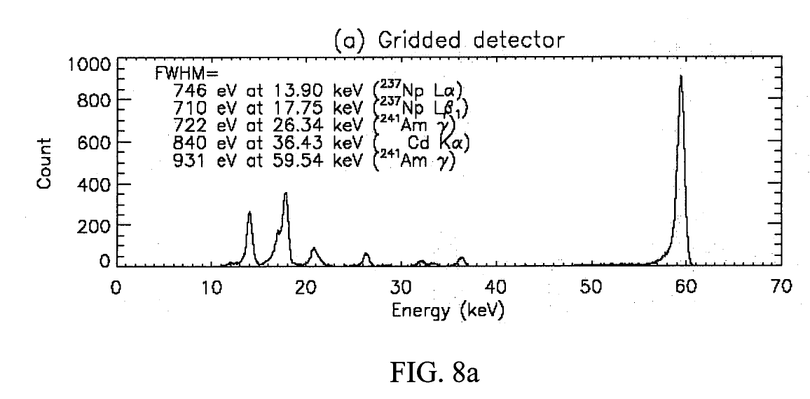

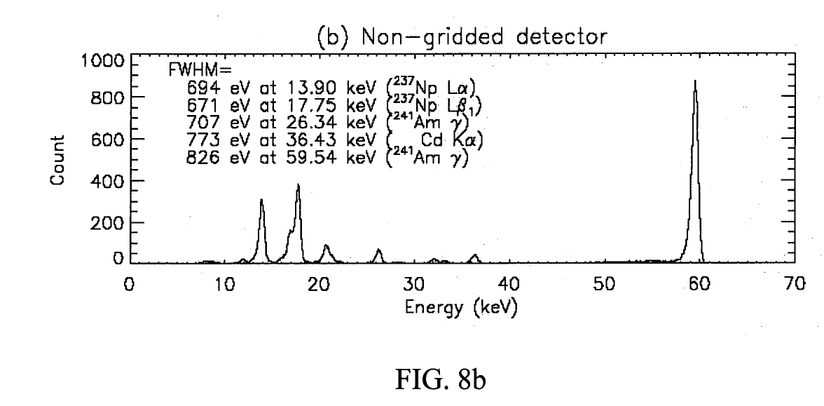

FIG. 8a shows the summed spectra from all pixels for the gridded detector. FIG. 8b shows the summed spectra from all pixels for the non-gridded detector. Also indicated in FIGS. 8a and 8b are the measured Gaussian line widths of the various spectral lines of Americium-241 (Am-241). At low energies, the line widths are comparable to the electronic noise (the pulser line width), indicating the absence of systematic effects, e.g. incomplete charge collection in the CdZnTe detector. For the gridded detector, the 59.94 keV line shows some residual low-energy tailing, with a FWHM of 931 eV. If one ignores the low-energy tail and fits the line only down to the lower half-maximum point, then the FWHM becomes 863 eV. In contrast, the non-gridded detector produces a more symmetric 59.54 keV line with a FWHM of 825 eV (756 eV if the low-energy tail is ignored).

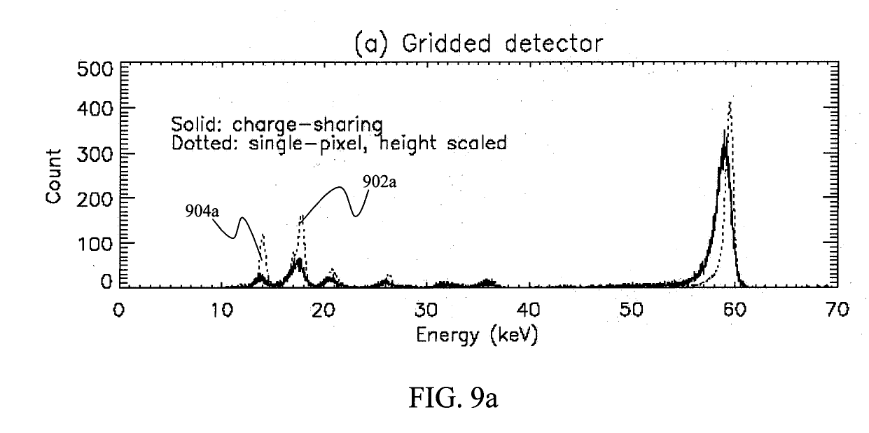

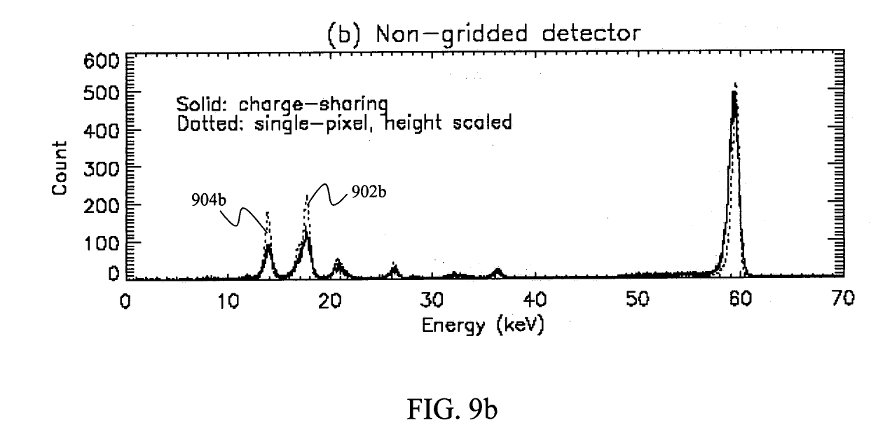

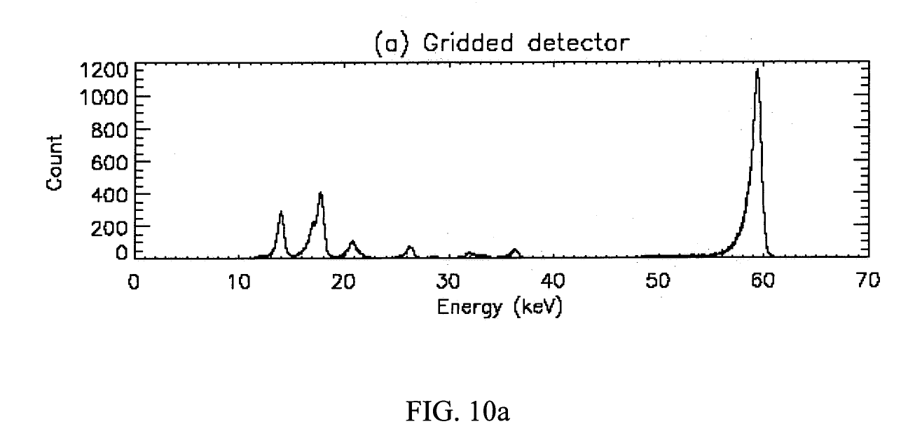

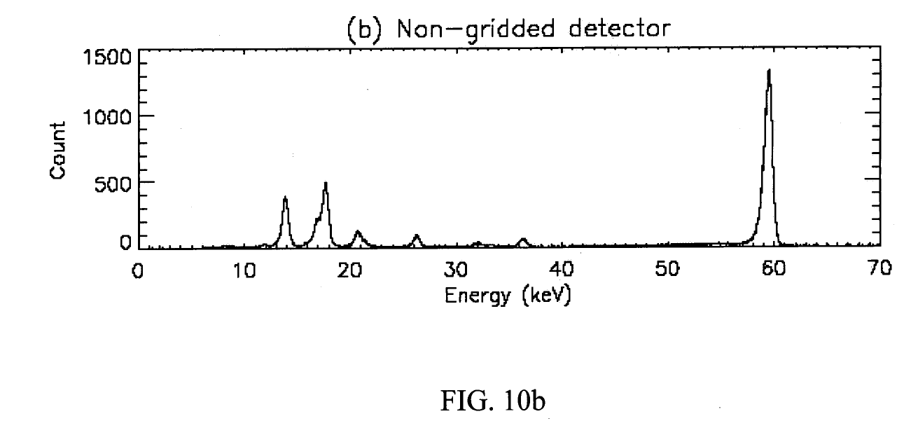

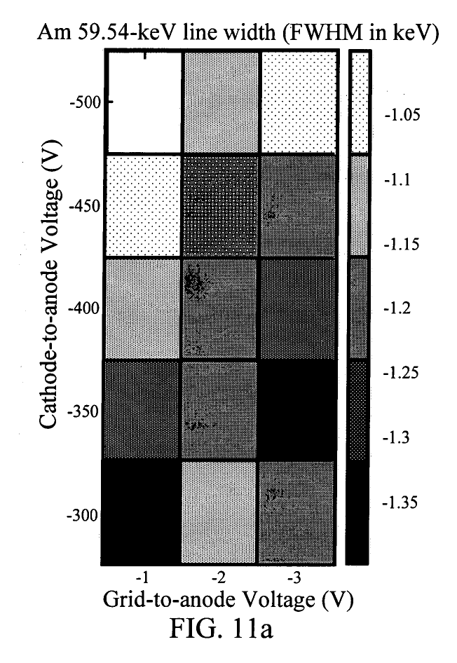

The recovery of charge-sharing events is important for detectors with pixels of this small size, since these events account for as much as 50% of the total. FIGS. 9a and 9b show the spectra from the two detectors obtained from charge-sharing events only. FIG. 9a depicts the spectra from the gridded detector, while FIG. 9b depicts the spectra from the non-gridded detector. For comparison purposes, the spectra from single-pixel events are dotted 902a and 902b and scaled to the same count rate, while the spectra from the charge-sharing events are solid 904a and 904b, respectively. The 59.94 keV lines measure a FWHM of 1.83 keV from the gridded detector, and 1.18 keV from the non-gridded detector. When a single-pixel and charge-sharing events are both summed together, the spectra thus produced are shown in FIG. 10a for the gridded detector and FIG. 10b for the non-gridded detector. The FWHM measurements are 1.23 keV and 973 eV for the gridded and non-gridded detectors, respectively.

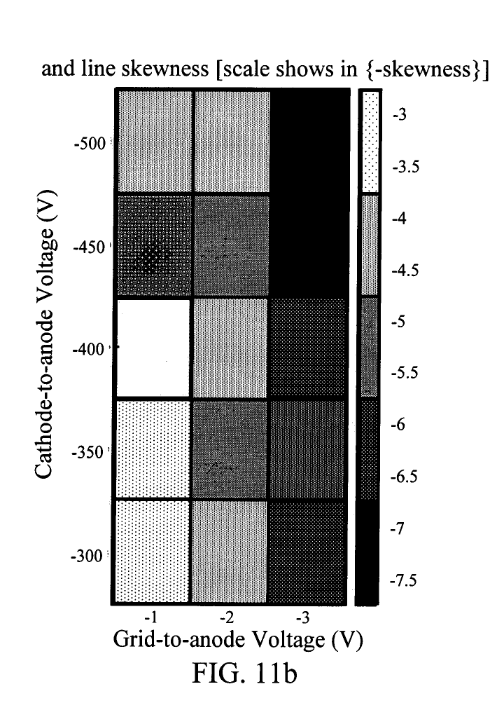

To minimize charge trapping in the CdZnTe crystal, electrode biases have been tuned appropriately. The energy resolution of the 59.94 keV line is measured at various bias combinations at the cathode and the steering electrode of the gridded detector. For each configuration, the FWHM and the skewness of the line are measured. FIG. 11a shows the trend of the FWHM and FIG. 11b shows the skewness of the 59.94 keV line of Am-241 at various bias pairs. Darkness is proportional to the FWHM magnitude in FIG. 11a, while the darkness is proportional to the skewness magnitude in FIG. 11b; therefore, the most desirable configurations are the brightest ones in each case. One skilled in the art will appreciate there is a partial tradeoff between FWHM and skewness. What is shown is that while greater grid-to-anode biases are always desirable up to −4 volts, producing a surface field strength of 4 V/50 micrometers=80,000 V/m, cathode biases that are too large will reduce the relative grid bias, and thus reduce the steering effect of the grid and increase tailing of the spectral line. On the other hand, cathode biases that are too low decrease the electron mean free path through the crystal, thus increasing charge trapping and subsequently the line width. Therefore, in one embodiment these two effects are balanced, by biasing the cathode by −450 volts, producing a bulk field strength of 450 V/2 millimeters=225,000 V/m.

The HEFT detectors are optimized to achieve good energy resolution with low power. The HEFT detectors have found applications in other fields of science. For instance, the detector may be utilized in a new generation of Mössbauer Powder Diffractometers, with the expectation of improving signal-to-noise ratio from about 1:1 to about 10:1 or better

1. A detector system comprising:
a patterned CdZnTe detector;
an ASIC bonded with the CdZnTe detector for receiving a signal from the CdZnTe detector; and
a microprocessor connected with the ASIC for operating the ASIC,
wherein signals are received by the CdZnTe detector, passed through the ASIC, and processed by the microprocessor.

2. The detector system of claim 1, wherein the patterned CdZnTe detector comprises:
a single CdZnTe crystal having a first side and a second side;
a anode plane connected with the first side of the CdZnTe crystal, wherein the anode plane comprises:
a plurality of pixels; and
a guard ring surrounding the plurality of pixels; and
a cathode connected with the second side of the CdZnTe crystal.

3. The detector system of claim 2, wherein the anode plane further comprises a grid, wherein the grid separates a first pixel from a second pixel in the plurality of pixels.

4. The detector system of claim 1, wherein the ASIC comprises:
a preamplifier having a preamplifier output;
a shaping amplifier connected with the preamplifier output;
a discriminator connected with the shaping amplifier for identifying a desired signal; and
a sampling and pulsing circuit connected with the preamplifier output.

5. The detector system of claim 4, wherein the sampling and pulsing circuits comprise a plurality of switched capacitors.

6. A method of making a detector system comprising acts of:
bonding a CdZnTe detector to an ASIC; and
connecting a microprocessor to the ASIC.

7. The method of claim 6, wherein the act of bonding is selected from a group consisting of: indium bump bonding and conductive epoxy and gold stump bonding.

8. The method of claim 6, further comprising an act of patterning the CdZnTe detector.

9. The method of claim 8, wherein the act of patterning is selected from a group consisting of: patterning the CdZnTe detector by forming a plurality of pixels separated by a gap and patterning the CdZnTe detector by forming a plurality of pixels separated by a gap and a gird.

10. A method of determining event triggers comprising acts of:
preliminary screening event triggers for events that trigger more than one-pixel or non-adjacent pixels;
removing systematic noise;
calculating a first pulse height resulting in a first pulse height calculation;
passing the first pulse height calculation to a discriminator;
eliminating false triggers;
calculating a second pulse height;
summing any second pulse height pairs that result from adjacent-pixel triggers.
